(19) United States
(12) Patent Application Publication
(10) Pub. No.: US 2015/0035300 A1
(43) Pub. Date: Feb. 5, 2015

(54) MOTOR VEHICLE DOOR LOCK

(71) Applicant: Kiekert AG, Heiligenhaus (DE)

(72) Inventors: David Taylor, Livonia, MI (US); Scott Davis, Clinton Township, MI (US)

(73) Assignee: Kiekert AG, Heiligenhaus (DE)

(21) Appl. No.: 13/957,554

(22) Filed: Aug. 2, 2013

(51) Int. Cl. E05B 85/02; H01B 5/02; F16H 21/16; E05B 9/00; E05B 15/00

(52) U.S. Cl. CPC E05B 85/02; E05B 9/00; E05B 15/00; F16H 21/16; H01B 5/02
USPC 292/337; 74/89

(57) ABSTRACT

A motor vehicle door lock that is equipped with at least one locking mechanism, one lock housing (1), a drive unit (2) arranged in the lock housing (1), and with at least one output element (3, 4) acted upon by the drive unit (2). The drive unit (2) is enclosed in a drive housing (8, 9), that is separate from the lock housing (1), is arranged therein, and is sealed relative to the lock housing (1). The output element (3, 4) is designed in two parts, with an interior element (3) arranged in the drive housing (8, 9) and an exterior element (4) that is mechanically coupled with the interior element (3), and is sealed relative to the drive housing (8, 9) and is arranged on the outside thereof.

The invention relates to a motor vehicle door lock, with at least one locking mechanism, one lock housing, a drive unit arranged in the lock housing, and with at least one output element acted upon by the drive unit, with the drive unit being enclosed in a drive housing, that is separate from the lock housing, is arranged therein, and is sealed relative to the lock housing.

### BACKGROUND

Typically, the locking mechanism is composed of a rotary latch and of a catch interacting therewith. A locking bolt on the motor vehicle body is captured by the rotary latch and secured in this position by the catch. In order to open a motor vehicle door associated with the motor vehicle door lock, and therefore in order to release the locking bolt, the catch must be lifted from the rotary latch. Generally, the lock housing consists of two parts and is composed of a metallic lock box and a lock housing made of plastic.

In a motor vehicle door lock of a design referred to above, as specified for example in DE 101 00 010 B4 or in DE 101 00 008 B4, the output element of the drive unit is a cam wheel arranged on the outside of the drive housing. In addition, the drive shaft of the cam wheel passes through the wall of the drive housing and is sealed by means of a rotary transmission. In detail, the cam wheel is coupled for this purpose with the drive shaft as a component of a worm gear.

The worm gear itself is rotated by a worm shaft. In this way, the drive unit and specifically the drive motor is to be protected optimally against intrusion of moisture. The motor vehicle door lock in prior art is a so-called electric lock that is equipped with an electric motor opening aid.

Also, from DE 37 51 274 T2, a door locking device is known that is claimed to be easy to install as a unit in a motor vehicle. For this purpose, a drive unit is provided that can control a locking arm to move into a locked position and into an unlocked position. In conjunction with the locking arm, the drive unit is arranged as an output element in the lock housing.

The lock housing is composed of a base section and a cover section made of plastic. In addition, according to the section view in FIG. 5, connecting pins can be seen in the lock housing.

### SUMMARY

The prior art is not satisfactory in all aspects. For example, the motor vehicle door locks according to DE 101 00 010 B4 or in DE 101 00 008 B4 are relatively tall in terms of their structure because the output element, or the cam wheel, is arranged outside the drive housing quasi in extension of the output shaft of the worm gear. In addition, this means that the output element is practically located in the center of the drive housing, possibly making additional transmission elements necessary in order to be able to convert the control movements of the drive unit to the corresponding functional positions. In the cited prior art this is not problematic because there the cam wheel acts directly on the catch as a component of the locking mechanism. This can be attributed to the fact that the motor vehicle door lock in the prior art is an electric lock.

However, if a universal design is to be pursued, the central arrangement of the output element and the relatively great extension of the lock housing in the prior art impede an extensive application. Here, the invention intends to create an overall solution.

The invention addresses the problem of developing a motor vehicle door lock of this type so that the drive unit can be used for universal applications and, in conjunction with the associated drive housing, is convincing due to an especially compact design that is protected against atmospheric influences.

In solving this technical problem, a motor vehicle door lock has an output element designed in two parts with an interior element arranged in the drive housing and an exterior element that is mechanically coupled with the interior element, and is sealed and arranged outside in relation to the drive housing.

According to the invention, and in contrast to typical prior art, this design therefore operates with an output element that is at least partially arranged inside the drive housing. In fact, the interior element is located inside the drive housing as a component of the output element, whereas the exterior element as an additional component of the output element is arranged outside the drive housing. In order for control movements of the drive unit to be able to be transmitted via the interior element to the exterior element, the exterior element and the interior element are coupled mechanically. In addition, the exterior element is sealed relative to the drive housing so that the drive unit in conjunction with the interior element is hermetically sealed inside the drive housing and is protected against dust, water, etc.

According to an additional advantageous embodiment, the output element is arranged in a recess of the drive housing. According to the invention, this relocates the output element to a marginally exposed position in relation to the drive housing. This makes it possible, on the one hand, to design the drive housing with an especially narrow structure while, on the other hand, makes it suitable for universal arrangements and functions. In fact, the marginal placement of the output element in the recess of the drive housing offers the general possibility of performing all control functions required inside a motor vehicle door lock by means of the drive unit.

In principle, for example, the drive unit is able to act on an output element designed as a locking element. As an alternative, the output element may also be a component of the locking mechanism, or act with the locking mechanism in terms of the functions “pull shut” or “open”. In addition, functions such as an anti-theft mechanism, a child safety mechanism, etc. are possible and can be realized with reference to the design according to the invention.

This means that the drive housing with the drive unit inside and the interior element as a component of the output element can be used in principle for any control function inside a motor vehicle door lock. This is possible when taking into consideration the especially compact and narrow structure of the drive housing as well as taking into consideration the special fact that due to the two-part design of the output element, with the exterior element that is sealed relative to the drive housing and is arranged outside thereof and with the interior element provided on the inside, sealing problems or functional problems are not to be expected.

According to an additional advantageous embodiment, the exterior element is supported on the drive housing. For this purpose, the drive housing is advantageously equipped with a support recess for the exterior element. Usually, the support recess is composed of a cylinder segment surface and a foot plate. This means that the support recess configured as a cylinder segment surface with foot plate is easy to define on the outside of the drive housing. At the same time, perfect guidance and support of the exterior element in and with the help of this support recess is possible.

In addition, the support recess is generally equipped with a sealed rotary transmission. This rotary transmission ensures that a connecting pin between the interior element and the exterior element can be passed in a sealed condition through the rotary transmission in the area of the support recess. By means of the connecting pin, the interior element provided inside the drive housing is coupled mechanically with the exterior element. This can be accomplished by means of a torsion-proof connection, for example a bolted connection, a latch connection, a serrated connection, or also combinations thereof.

Advantageously, the rotary transmission is located in the foot plate as a component of the support recess. Thereby, the foot plate or the support recess at the edge of the drive housing function as a rotary bearing device for the output element. The more so since the interior element and the exterior element are typically each designed as rocking levers. This means that, in order to implement functional positions initiated by means of the drive unit, the interior element and the exterior element, or the rocking levers in each case, perform inside the motor vehicle door lock a rotating motion in relation to the connecting pin passing through the rotary transmission as the axis of rotation.

In this context, the two angles of rotation are usually joined to each other at an obtuse angle. Of course, the angle enclosed by the two rocking levers may also be varied. That can easily be accomplished by means of the connecting pin that, for example, engages or is able to engage a different gearing.

In order to further increase the tightness of the seal of the drive housing, the drive housing is usually also equipped with embedded connecting pins for an electrical connection with a contact element. For this purpose, the connecting pins are advantageously molded into the drive housing made of plastic. This means that in the course of the plastic injection molding process for the production of the drive housing, the plastic defining the drive housing is injected around the connecting pins. From the start, this prevents the occurrence of sealing problems.

The more so because electrical connecting lines starting from the connecting pins and leading to an electric motor as component of the drive unit are typically electrically connected with, or joined to a foot plate. In fact, the drive housing is usually composed of the foot plate in question and a head cover, and therefore consists of two parts.

The foot plate usually is equipped with the connecting pins in question. In contrast, the head cover is usually equipped with the support recess for the exterior element as a component of the output element.

The power supply lines for the electric motor starting from the connecting pins can be connected on the inside with the drive housing, and, advantageously, with the foot plate. It is also possible to define the power supply lines in the foot plate for example as lines embedded therein. In this case, plastic is injected around the supply lines in question together with the connecting pins in the course of the plastic injection molding process for the production of the drive housing. In principle it is also possible, and lies within the scope of the invention, to work in this respect with circuit tracks applied to the drive housing, embedded circuit tracks, etc. In addition, it is advantageous to ensure that the ends of these supply lines automatically make electrical contact with the electric motor placed on the inside when the foot plate and the head cover, as the two components of the drive housing, are joined.

As a result, a motor vehicle door lock is made available whose functional reliability can be especially high, because the drive unit with the associated electric motor is housed in a separate drive housing that is equipped with a hermetic seal regarding its environment, and therefore also regarding the surrounding lock housing. This practically excludes possible functional problems, even over the long term.

In addition, the drive housing is especially compact and has a narrow structure so that it is possible to install it without problems inside the lock housing. Due to the marginal placement of the output element, it is also possible to realize all imaginable functional states by means of the drive unit inside the motor vehicle door lock. These must be considered to be essential advantages.

### BRIEF DESCRIPTION OF THE DRAWINGS

Below, the invention is explained in detail with reference to a drawing showing a single embodiment.

FIG. 1 shows a top view of the motor vehicle door lock according to the invention,

FIG. 2 shows a detail view of the object according to FIG. 1 in the area of the drive unit, with the foot plate removed,

FIGS. 3 and 4 show different views of the drive housing inside the lock housing, opened partially.

### DETAILED DESCRIPTION

The Figures show a motor vehicle door lock that is or may be configured as a side door lock, a rear hatch lock, etc. The motor vehicle door lock shown here interacts with a locking bolt arranged on the motor vehicle body. For this purpose, the motor vehicle door lock is equipped with a lock housing 1. In the lock housing 1, a locking mechanism (not shown in detail in that any suitable locking mechanism can used) is supported that interacts in familiar manner with the locking bolt (also not shown).

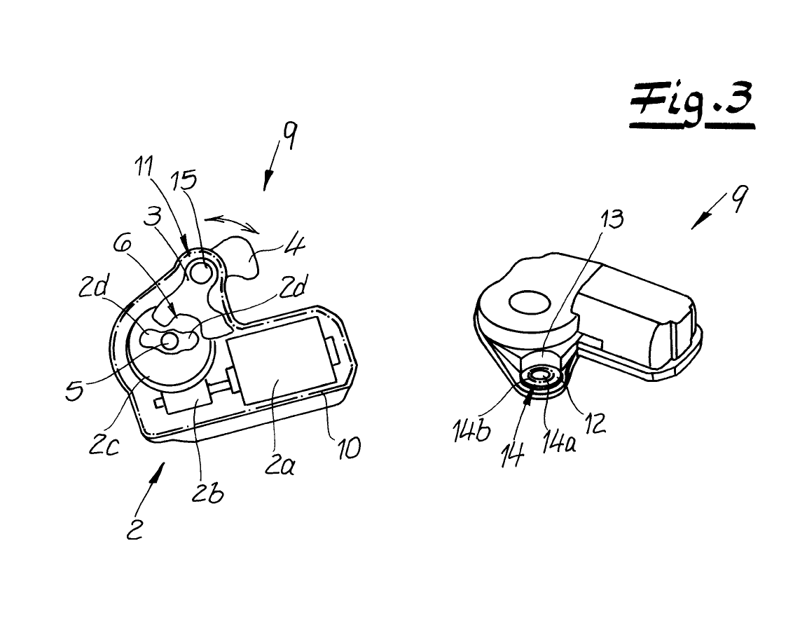

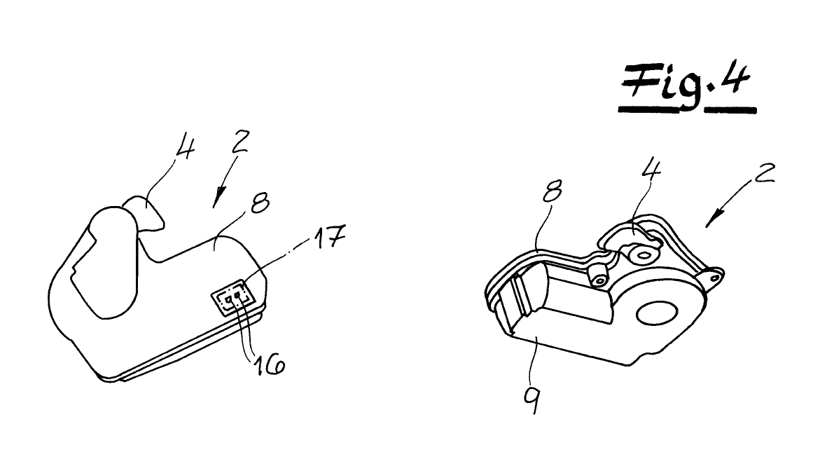

In addition, a drive unit 2 is located in the lock housing 1. The drive unit 2 acts upon at least one output element 3, 4, as can be seen especially clearly in FIGS. 3 and 4. The drive unit itself is composed of an electric motor 2a, a worm shaft 2b connected with an output shaft of the electric motor 2a, and a worm wheel 2c meshing with the worm shaft 2b.

Depending on the input by the electric motor 2a, the worm wheel 2c performs clockwise or counter-clockwise movements around an associated axis of rotation 5. The Figures also show actuation cams 2d on the worm wheel 2c that act upon the output element 3, 4. For this purpose, the output element 3, 4 is equipped with a fork recess 6 with stop surfaces that interact with the actuation cams 2d.

Within the context of the exemplary embodiment, the output element 3, 4 may consist of a locking element and specifically of a central locking element 3, 4. In principle, the interaction between the actuation cams 2d with the fork recess 6 in the locking lever 3, 4 in question may proceed as specified in DE 199 55 882 C2 of the applicant, which is hereby incorporated by reference. As explained in that document, at least the positions “locked” and “unlocked” of the locking element 3, 4 respectively of the output element 3, 4 can be implemented by means of the drive unit 2.

For this purpose the output element, respectively the locking element 3, 4 in the exemplary embodiment, are connected with a coupling lever 7 that renders an associated actuation lever chain ineffective, respectively interrupts it in the “locked” position while, in the “unlocked” position, providing an uninterrupted mechanical connection of the actuation lever chain from an outside door handle or an inside door handle all the way to the locking mechanism for the purpose of triggering it. In principle, this is known from the prior art, the cited example of which is referred to here. Beyond that, the design of the output element 3, 4 as a locking element 3, 4 only serves as an example in this case. Thus, according to the invention, the drive unit 2 could also act directly upon the locking mechanism for the purpose of opening it, or do so in the course of a locking process. In that case, for example, the output element 3, 4 would act directly or indirectly on the catch as a component of the locking mechanism consisting of rotary latch and catch. This, however, is not shown.

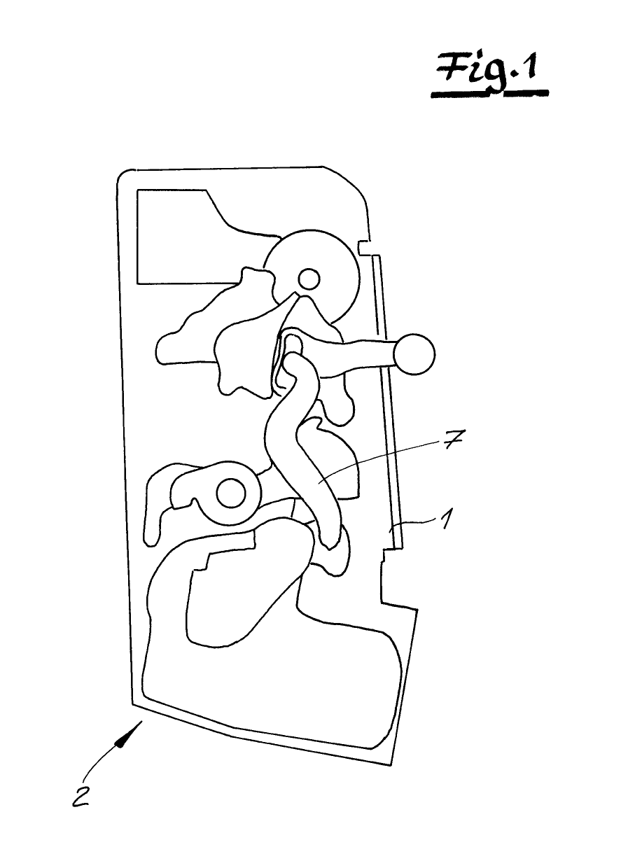

A comparative view of FIGS. 3 and 4 and FIGS. 1 and 2 shows clearly that the drive unit 2 is enclosed by a separate drive housing 8, 9. In this case, the drive housing 8, 9 consists of two parts and is composed of a foot plate 8 and a head cover 9. FIGS. 3 and 4 show that the foot plate 8 and the head cover 9 are sealed relative to each other. For this purpose, a continuous gasket 10 is provided.

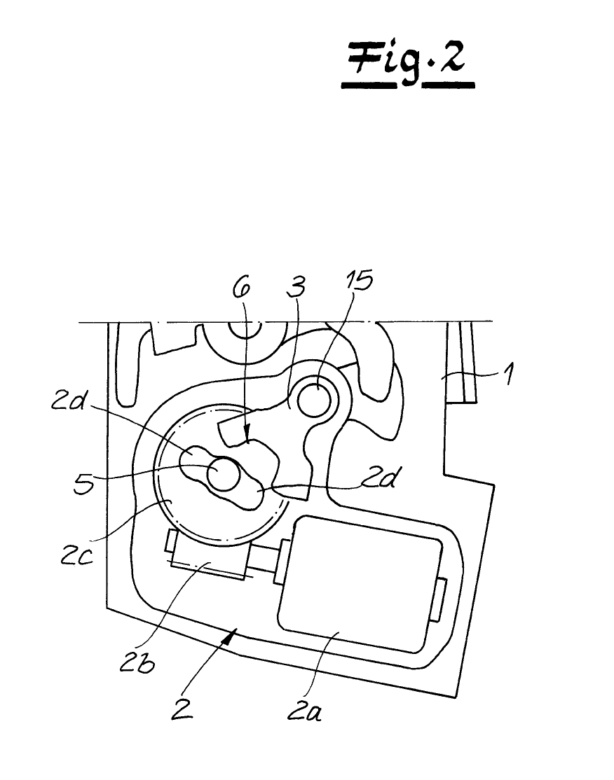

The continuous gasket 10 may be placed in a recess in the foot plate 8 and/or the head cover 9. However, it is also possible within the scope of the invention for the gasket 10 to be connected with the head cover 9, for example, and to be injected onto the head cover 9 in the course of a two-component plastic injection process, for example. In any case, the drive unit 2 is a two-part design and therefore comprises a drive housing 8, 9 that is separated from the lock housing 1. In addition, the drive housing 8, 9 is sealed relative to the lock housing 1, and is therefore also sealed relative to the environment. Finally, the drive housing 8, 9 as a whole is arranged inside the lock housing 1, as shown in FIGS. 1 and 2.

According to the invention, the output element 3, 4 consists of two parts. In fact, the output element is composed of an interior element 3 and an exterior element 4. The interior element 3 is arranged inside the drive housing 8, 9. For this purpose, the interior element 3 is equipped with the fork recess 6 referred to above and therefore interacts with the drive unit 2.

By contrast, the exterior element 4 is arranged outside the drive housing 8, 9 and is sealed relative to the drive housing 8, 9.

As a whole, the output element 3, 4 is arranged in a recess 11 of the drive housing 8, 9. In addition, the output element 3, 4 is located at the edge of the drive housing 8, 9 in question so that an overall marginally exposed position of the output element 3, 4 can be observed. This makes it possible to mechanically couple the output element 3, 4 especially quickly and easily with the coupling lever 7 during the assembly, as shown in FIG. 1 of the exemplary embodiment. The exterior element 4 as a component of the output element 3, 4 is supported on the drive housing 8, 9. For this purpose, the drive housing 8, 9 comprises a support recess 12, 13.

The support recess 12, 13 is designed as a cylinder segment surface 13, on the one hand, and as a foot plate 12, on the other hand. In addition, the support recess 12, 13 comprises a sealed rotary transmission 14 for a connecting pin 15 between the interior element 3 and the exterior element 4. The interior element 3 and the exterior element 4 are coupled mechanically by means of the connecting pin 15. In addition, the connecting pin 15 defines a common axis of rotation or a swivel axis.

In fact, regarding the exemplary embodiment, it can be observed that the interior element 3 and the exterior element 4 each are designed as rocking levers. The interior element 3 therefore represents an interior rocking lever 3 while the exterior element 4 is designed as an exterior rocking lever 4. The mechanical coupling of the interior rocking lever 3 and the exterior rocking lever 4 is accomplished by means of the connecting pin 15 that, in the exemplary embodiment, is connected with the exterior rocking lever 4 and stands upright thereon. The connecting pin 15 engages a recess in the interior rocking lever 3. Here, possible serrations on the outside of the connecting pin 15 and on the inside of the recess in the interior rocking lever 3 ensure a torsion-proof coupling. This also offers the possibility to vary the angle between the two rocking levers 3, 4, if required. According to the embodiment in FIGS. 3 and 4, the two rocking levers 3, 4 are connected with each other at an obtuse angle, although this should only be considered as an example.

The rotary transmission 14 is provided in the foot plate 12 of the support recess 12, 13. The rotary transmission 14 is distinguished by a bore 14a with circular cross-section for accepting the connecting pin 15, on the one hand, and by a gasket 14b surrounding the bore, on the other hand. Since the exterior rocking lever 4 engages the support recess 12, 13 with a more or less positive fit, an optimal seal in terms of dust, water, etc. is achieved in this location.

In addition, in conjunction with the connecting pin 15, the support recess 12, 13 ensures that the exterior rocking lever 4 receives the desired pivoting support in that the connecting pin 15 passes through the appropriately circular bore 14a. The desired seal is provided by the gasket 14b against which the exterior rocking lever 4 rests.

FIGS. 3 and 4 also show electrical contacts such as connecting pins 16 embedded in the drive housing 8, 9. By means of the connecting pins 16, an electrical connection is established with a contact element 17 (merely indicated and not shown in detail). By means of connecting lines (not shown), the connecting pins 16 are electrically connected with the electric motor 2a. Like the connecting pins 16, these electric connecting lines are formed on the foot plate 8 as a component of the drive housing 8, 9.

In the exemplary embodiment, the connecting pins 16 are molded into the drive housing 8, 9 made of plastic. In fact, plastic is injected around the connecting pins 16 in the course of the production of the foot plate 8. A comparable process may apply to the connecting lines for the electrical connection of the connecting pins 16 with the electric motor 2a.

It can be seen that the foot plate 8 as component of the drive housing 8, 9 comprises the connecting pins 16. By contrast, the head cover 9 is equipped with the support recess 12, 13 for the exterior rocking lever 4. This makes it possible for the head cover 9 to be first placed together with the drive unit 2 inside the lock housing 1, as shown in FIG. 2. Following that, the output element 3, 4, or the exterior rocking lever 4 in the exemplary embodiment, is mechanically coupled with the coupling lever 7. Finally, the foot plate 8 is connected in a sealing manner with the head cover 9 so that, as a result, the drive housing 8, 9 is hermetically sealed as desired inside the lock housing 1. When installing the head cover 8, it is possible to automatically establish a contact between the electric motor 2a and the connecting lines so that a continuous electrical connection is established all the way to the connecting pins 16. This makes it possible to directly control the drive unit 2 electrically when, as the next step, the contact element 17 is mounted on the connecting pins 16.

1. A motor vehicle door lock, comprising
a locking mechanism,
a lock housing in which the locking mechanism is retained,
a drive unit arranged in the lock housing, and
an output element acted upon by the drive unit and connected to or disposed for interaction with the locking mechanism,
wherein the drive unit is enclosed in a drive housing, that is separate from the lock housing, is arranged therein, and is sealed relative to the lock housing,
wherein the output element is designed in two parts with an interior element arranged in the drive housing and an exterior element that is mechanically coupled with the interior element, which exterior element is sealed relative to the drive housing and is arranged on the outside thereof.

2. The motor vehicle door lock according to claim 1, wherein the output element is arranged in a recess of the drive housing.

3. The motor vehicle door lock according to claim 1, wherein the exterior element is supported on the drive housing.

4. The motor vehicle door lock according to claim 1, wherein the drive housing comprises a support recess for the exterior element.

5. The motor vehicle door lock according to claim 4, wherein the support recess is designed as a cylinder segment surface with a foot plate.

6. The motor vehicle door lock according to claim 4, wherein the support recess comprises a sealed rotary transmission for a connecting pin between the interior element and the exterior element.

7. The motor vehicle door lock according to claim 6, wherein the rotary transmission is provided in the foot plate of the support recess.

8. The motor vehicle door lock according to claim 1, wherein the interior element and the exterior element are each designed as rocking levers.

9. The motor vehicle door lock according to claim 8, wherein the two rocking levers are connected with each other at an obtuse angle.

10. The motor vehicle door lock according to claim 1, wherein the drive housing comprises embedded connecting pins for the electrical connection with a contact element.

11. The motor vehicle door lock according to claim 10, wherein the connecting pins are inserted into the drive housing, and the drive housing is made of plastic.

12. The motor vehicle door lock according to claim 1, wherein the drive housing is designed as two parts, with a foot plate and a head cover.

13. The motor vehicle door lock according to claim 12, wherein the foot plate comprises the connecting pins and the head cover comprises the support recess.
